(19) United States
(12) Patent Application Publication
(10) Pub. No.: US 2009/0225138 A1
(43) Pub. Date: Sep. 10, 2009

(54) LIQUID EJECTION HEAD, LIQUID EJECTION APPARATUS

(75) Inventor: Shunsuke Watanabe, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/393,496

(22) Filed: Feb. 26, 2009

(30) Foreign Application Priority Data
Feb. 26, 2008 (JP) 2008-045312
Feb. 25, 2009 (JP) 2009-042326

(51) Int. Cl. B41J 2/045

(52) U.S. Cl. 347/70

(57) ABSTRACT

A liquid ejection head includes pressure generating chambers 11, piezoelectric elements 17, and a reservoir 22. The reservoir 22 communicates with a plurality of ink inlets 21a and 21b. In a confluence area of liquid supplied through the ink inlets 21a and 21b, a wall opposite to the pressure generating chambers 11 projects to form a narrowed portion 22a so that the width of this part is smaller than the width of the other parts.

The entire disclosure of Japanese Patent Application No. 2008-045312, filed Feb. 26, 2008 is incorporated by reference herein. And the entire disclosure of Japanese Patent Application No. 2009-042326, filed Feb. 25, 2009 is incorporated by reference herein.

### BACKGROUND OF THE INVENTION

1. Field of the Invention

The present invention relates to a liquid ejection head and a liquid ejection apparatus that eject liquid from nozzle orifices, and more specifically, it is useful when applied to an ink jet recording head and an ink jet recording apparatus that eject ink as liquid.

2. Description of the Related Art

An ink jet recording head is an example of a liquid ejection head. Some ink jet recording heads include an actuator unit provided with piezoelectric elements and pressure generating chambers, a nozzle plate provided with nozzle orifices that communicate with the pressure generating chambers and eject ink, and a passage unit provided with a reservoir serving as a common ink chamber of the pressure generating chambers.

A known reservoir of such an ink jet recording head is configured to have a width that decreases with distance from a liquid inlet disposed in the central part thereof (JP-A-2002-292868). Another known reservoir is configured to branch. The directions of branch ports correspond to the flows. The passage resistances of branch passages are thereby made uniform (JP-A-2006-297897). The former is devised to increase the flow rate in an area prone to accumulation of bubbles to prevent the accumulation of bubbles. The latter is devised to prevent bubbles from remaining in the reservoir by filling the pressure generating chambers with ink at the same time.

However, the above-described reservoir structures cannot deal with the increase in length of an ink jet recording head. Hitherto, ink has been introduced into a reservoir through a liquid inlet disposed in the central part of the reservoir. However, in the case of a long-sized ink jet recording head with a length exceeding, for example, one inch, the reservoir is also long-sized in proportion thereto. As a result, the reservoir has a high pressure loss. To eliminate the effect of such a high pressure loss and to ensure ink supply performance, two or more liquid inlets need to be provided. However, in this case, a new problem arises that, in the ink confluence area, the flows stagnate, and the discharge of bubbles is difficult. As described above, the techniques disclosed in the Patent Documents 1 and 2 cannot deal with the new problem of the worsening of bubble discharge performance caused by stagnation of ink in the case where a plurality of liquid inlets are provided. The reason is that both techniques are premised on the case where one liquid inlet is provided to one reservoir.

Such a problem exists not only in an ink jet recording head but also in liquid ejection heads that eject liquid other than ink.

### SUMMARY OF THE INVENTION

In view of the problem with the above known techniques, an object of the invention is to provide a liquid ejection head and a liquid ejection apparatus that can improve the bubble discharge performance in a reservoir without generating stagnation in a confluence area of liquid in a case where a plurality of liquid inlets are provided.

To solve the above problem, in an embodiment of the invention, a liquid ejection head includes pressure generating chambers that are provided side by side in a first substrate so as to be made to eject liquid through nozzle orifices by pressure variation, and a reservoir that is provided in a second substrate so as to supply the liquid to the pressure generating chambers and to constitute a common liquid chamber provided in the direction in which the pressure generating chambers are provided side by side. The reservoir is supplied with the liquid through a plurality of liquid inlets, and the cross-sectional area of the reservoir in a plane perpendicular to the line joining the liquid inlets in a confluence area of the liquid supplied through the liquid inlets is smaller than the cross-sectional area of the reservoir in a plane perpendicular to the line joining the liquid inlets in a predetermined area other than the confluence area. The first substrate and the second substrate may be the same substrate or different substrates.

According to this embodiment, stagnation in a confluence area of liquid supplied through a plurality of liquid inlets can be eliminated by a small width portion in the confluence area. Therefore, bubbles accumulating due to stagnation can be favorably discharged. In addition, the flow of liquid supplied through the reservoir to the pressure generating chambers can be made closer to being parallel to the longitudinal direction of the pressure generating chambers. Therefore, also in this regard, favorable bubble discharge performance can be ensured.

When a plurality of heads or a plurality of reservoirs are simply arranged side by side to increase the length, variation in structural strength of the heads or reservoirs, variation in static pressure of the reservoirs, variation in compliance of the reservoirs, and so forth cause cross talk. However, in this embodiment, even when the length of a head is increased, a common reservoir can be easily used. Therefore, the structural strength of the heads or reservoirs, the static pressure of the reservoirs, the compliance of the reservoirs, and so forth can be made uniform to prevent cross talk, and the bubble discharge performance can be made sufficiently favorable.

The reservoir may supply the liquid to the pressure generating chambers through liquid supply ports in the direction along the surface of the second substrate, and an inner wall of the reservoir that faces the liquid supply ports in the confluence area may project toward the liquid supply ports. In this case, the above-described effect can be achieved in a liquid ejection head in which the liquid is supplied to the pressure generating chambers through liquid supply ports from the direction parallel to the surface direction of the substrate. The reservoir may supply the liquid to the pressure generating chambers through liquid supply ports in the direction of the thickness of the second substrate, and inner walls of the reservoir that extend with the liquid supply ports therebetween in the direction in which the pressure generating chambers are provided side by side, may project toward each other in the confluence area. In this case, the above-described effect can be achieved in a liquid ejection head in which the liquid is supplied to the pressure generating chambers through liquid supply ports from the direction parallel to the thickness direction of the substrate. It is preferable that both of the inner walls of the reservoir that extend with the liquid supply ports therebetween in the direction in which the pressure generating chambers are provided side by side, be distant from the liquid supply ports by a distance larger than the maximum diameter of bubbles that can spontaneously disappear, in the predetermined area. The reason is that the smaller the distance, the more easily harmful bubbles grow.

Reducing the width as described above can be easily achieved, for example, by forming at least one narrowed portion in the confluence area. It is preferable that the at least one narrowed portion have such a shape that the width gradually decreases in the direction in which the pressure generating chambers are provided side by side, from the sides of the liquid inlets toward the intermediate part between adjacent liquid inlets. The reason is that by making the liquid flow along the narrowed portion, bubbles can be effectively discharged. It is preferable that the width of the at least one narrowed portion gradually decrease along the flow line of the liquid. The reason is that the flow of the liquid is the most smooth, and therefore bubbles can be favorably discharged.

The at least one narrowed portion may include a plurality of narrowed portions provided in the reservoir. In this case, by forming a plurality of fluid confluence areas, stagnation of fluid in each confluence area can be eliminated. Therefore, this is useful particularly in the case where the size of a reservoir in the longitudinal direction is large.

In another embodiment of the invention, a liquid ejection apparatus has the above-described liquid ejection head.

According to this embodiment, high-speed printing can be achieved using a long-sized head, and in addition, the printing quality can be improved.

### BRIEF DESCRIPTION OF THE DRAWINGS

FIG. 1 is a sectional view of a liquid ejection head according to a first embodiment of the invention.

FIG. 2 is a plan view showing the reservoir portion of FIG. 1.

FIG. 3 is a plan view showing a case where the reservoir shown in FIG. 2 has no narrowed portion.

FIG. 4 is a sectional view of a liquid ejection head according to a second embodiment of the invention.

FIG. 5 is a plan view showing the reservoir portion of FIG. 4.

FIG. 6 is a schematic diagram of an ink jet recording apparatus according to an embodiment of the invention.

10, 110: ink jet recording head
11, 121: pressure generating chamber
12, 122: passage forming substrate
13, 134: nozzle orifice
14, 135: nozzle plate
15, 123: vibrating plate
16, 130: passage unit
17, 140: piezoelectric element
18: piezoelectric element unit
19: housing portion
20: case head
21, 138: ink inlet
22, 132: reservoir
22a, 132a: narrowed portion

### DESCRIPTION OF THE PREFERRED EMBODIMENTS

The preferred embodiments of the invention will now be described in detail with reference to the drawings.

### First Embodiment

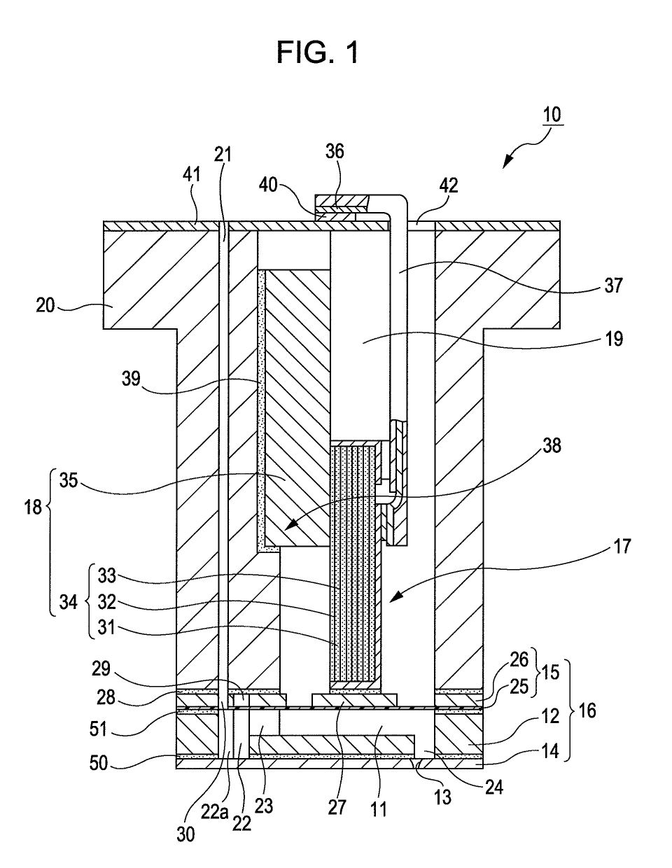

FIG. 1 is a sectional view of an ink jet recording head that is an example of a liquid ejection head according to a first embodiment of the invention. As shown in the figure, the ink jet recording head 10 has a passage unit 16. The passage unit 16 has a passage forming substrate 12 having a plurality of pressure generating chambers 11, a nozzle plate 14 in which are formed a plurality of nozzle orifices 13 communicating with the pressure generating chambers 11, and a vibrating plate 15 provided on the side of the passage forming substrate 12 opposite to the nozzle plate 14. In addition, the ink jet recording head 10 has a piezoelectric element unit 18 that has piezoelectric elements 17 provided in areas on the vibrating plate 15 corresponding to the pressure generating chambers 11, and a case head 20 that is fixed to the vibrating plate 15 and has a housing portion 19 in which the piezoelectric element unit 18 is housed.

In the surface layer part on one side of the passage forming substrate 12, a plurality of pressure generating chambers 11 are formed by partition walls and are provided side by side in the width direction thereof. For example, in this embodiment, in the passage forming substrate 12, a plurality of pressure generating chambers 11 are provided side by side. On the outer side of the row of the pressure generating chambers 11, a reservoir 22 to which ink is supplied through ink inlets 21 communicating with an ink supply means (not shown) outside the case head 20, is provided through the passage forming substrate 12 in the thickness direction. The reservoir 22 communicates with the pressure generating chambers 11 through ink supply ports 23. The pressure generating chambers 11 are supplied with ink from the ink supply means through the ink inlets 21 and the reservoir 22. The ink supply ports 23 have a width smaller than the width of the pressure generating chambers 11 and maintain constant passage resistance of ink that flows from the reservoir 22 into the pressure generating chambers 11. In addition, at the end of each pressure generating chamber 11 opposite to the reservoir 22, a nozzle communication hole 24 is formed through the passage forming substrate 12.

As described above, in this embodiment, ink is made to flow from the reservoir 22 through the ink supply ports 23 in the surface direction of the passage forming substrate 12, and thereby ink is supplied to the pressure generating chambers 11. That is, the passage forming substrate 12 is provided with pressure generating chambers 11, a reservoir 22, ink supply ports 23, and nozzle communication holes 24. Such a passage forming substrate 12 is formed of a silicon single crystal substrate. The above-described pressure generating chambers 11 and so forth provided in the passage forming substrate 12 are formed by etching the passage forming substrate 12.

To one side of the passage forming substrate 12, a nozzle plate 14 in which nozzle orifices 13 are formed is joined with adhesive 50. The nozzle orifices 13 communicate with the pressure generating chambers 11 through nozzle communication holes 24 provided in the passage forming substrate 12. On the other hand, to the other side of the passage forming substrate 12, that is, the side on which the pressure generating chambers 11 open, the vibrating plate 15 is joined. The pressure generating chambers 11 are sealed by this vibrating plate 15. The vibrating plate 15 is formed of a composite plate including an elastic film 25 that is formed of an elastic member, for example, a resin film, and a support plate 26 that supports this elastic film 25 and that is formed, for example, of a metallic material. The elastic film 25 side is joined to the passage forming substrate 12. In areas in the vibrating plate 15 facing the pressure generating chambers 11, islands 27 with which the distal ends of the piezoelectric elements 17 are in contact are provided. The distal end faces of these piezoelectric elements 17 are joined to the islands 27 with adhesive 28. In addition, in an area of the vibrating plate 15 facing the reservoir 22, a compliance portion 29 is provided. In the compliance portion 29, the support plate 26 is removed by etching, and therefore the compliance portion 29 consists substantially only of the elastic film 25. In this compliance portion 29, when a pressure change occurs in the reservoir 22, the elastic film 25 of this compliance portion 29 is deformed and thereby absorbs the pressure change and maintains a constant pressure in the reservoir 22. In addition, the vibrating plate 15 is provided with openings 30 so that the ink inlets 21 communicate with the reservoir 22. This vibrating plate 15 is joined to the passage forming substrate 12 with adhesive 51.

The piezoelectric elements 17 are integrally formed in a single piezoelectric element unit 18. Specifically, a piezoelectric material 31 is sandwiched between electrode forming materials 32 and 33, and thereby a piezoelectric element forming member 34 is formed. This piezoelectric element forming member 34 is cut into a comb-like shape so that the teeth correspond to the pressure generating chambers 11, and thereby the piezoelectric elements 17 are formed. Inactive areas of the piezoelectric elements 17 (the piezoelectric element forming member 34) that do not contribute to vibration, that is, the base ends of the piezoelectric elements 17 are fixed to a fixing substrate 35. In this embodiment, the piezoelectric elements 17 (the piezoelectric element forming member 34) and the fixing substrate 35 constitute the piezoelectric element unit 18. Near the base ends of the piezoelectric elements 17, and to the side opposite to the fixing substrate 35, a circuit board 37 that has wirings 36 supplying signals for driving the piezoelectric elements 17 is connected.

Such a piezoelectric element unit 18 is fixed with the distal ends of the piezoelectric elements 17 in contact with the islands 27 of the vibrating plate 15 as described above. For example, in this embodiment, a case head 20 is fixed on the top of the vibrating plate 15 as described above, the piezoelectric element unit 18 is housed in the housing portion 19 of this case head 20, and the side of the fixing substrate 35 opposite to the side to which the piezoelectric elements 17 are fixed is fixed to the case head 20. Specifically, in the housing portion 19 of the case head 20, a step portion 38 is provided. The fixing substrate 35 is joined to the step portion 38 of the case head 20 with adhesive 39.

In addition, to the top of the case head 20 is fixed a wiring board 41 provided with a plurality of conductive pads to which the wirings 36 of the circuit board 37 are connected. The housing portion 19 of the case head 20 is substantially closed by this wiring board 41. In an area of the wiring board 41 facing the housing portion 19 of the case head 20, a slit-like opening 42 is formed. The circuit board 37 is pulled out of the housing portion 19 through the opening 42 of the wiring board 41.

The circuit board 37 constituting the piezoelectric element unit 18 is formed, for example, in this embodiment, of a chip on film (COF) on which a driving IC (not shown) for driving the piezoelectric elements 17 is mounted. The base ends of the wirings 36 of the circuit board 37 are connected, for example, with solder or an anisotropic conductive material to the electrode forming materials 32 and 33 constituting the piezoelectric elements 17. On the other hand, the distal ends of the wirings 36 are connected to the conductive pads 40 of the wiring board 41. Specifically, the distal end of the circuit board 37 pulled out of the housing portion 19 through the opening 42 of the wiring board 41 is folded along the surface of the wiring board 41, and the wirings 36 are connected to the conductive pads 40 of the wiring board 41.

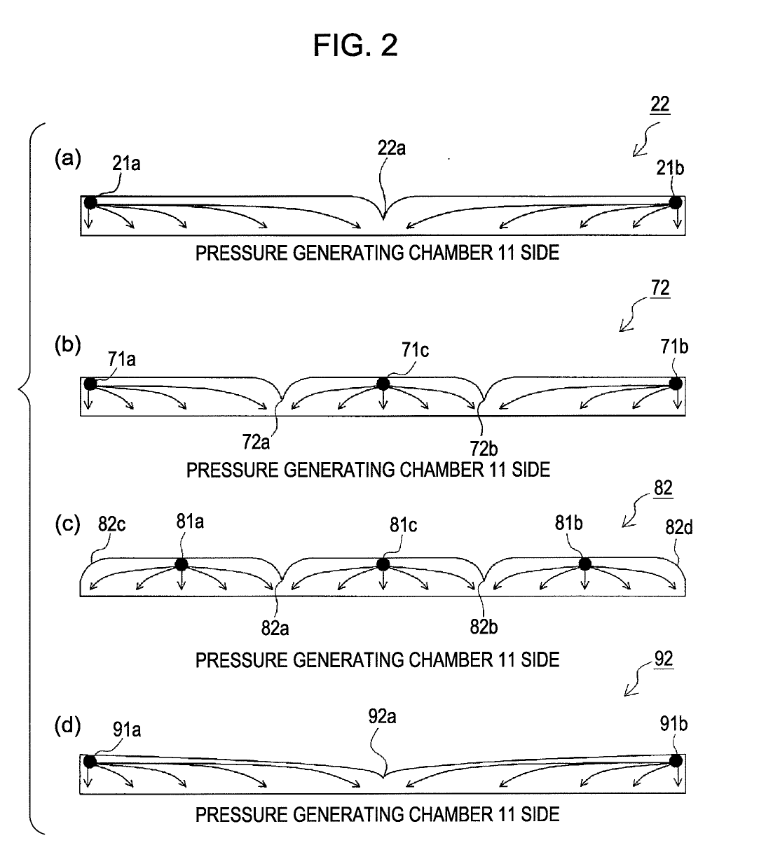

FIG. 2 illustrates the planar shapes of various types of reservoirs according to this embodiment. Although four types of FIGS. 2 (a) to 2 (d) are shown, the invention is not limited to these. A first common characteristic of the reservoirs 22, 72, 82, and 92 in this embodiment is that the reservoirs communicate with a plurality of (two or three in the figure) ink inlets (21a and 21b), (71a to 71c), (81a to 81c), (91a and 91b). A second common characteristic is that, in confluence areas of ink supplied from the ink inlets (21a and 21b), (71a to 71c), (81a to 81c), (91a and 91b), the wall (the upper wall in the figure) opposite to the pressure generating chambers 11 (see FIG. 1) is made to project, and narrowed portions 22a, (72a and 72b), (82a and 82b), 92a are formed so that the width, the size in a direction (the vertical direction in the figure) perpendicular to the longitudinal direction (the horizontal direction in the figure), of these portions is smaller than the width of the other portions. That is, to reduce the pressure loss of ink owing to the increase in length of the reservoir 22, first, the number of the ink inlets (21a and 21b), (71a to 71c), (81a to 81c), (91a and 91b) is determined. Then, in each case, to eliminate the stagnation of ink in the reservoir 22, narrowed portions 22a, (72a, 72b), (82a, 82b), 92a are formed in the above confluence areas.

FIG. 2 (a) shows a case where a reservoir 22 communicates with two ink inlets 21a and 21b at both ends thereof in the longitudinal direction. The flow lines in this case are shown by arrows in the figure. In a confluence area where the front ends of the arrows meet, a narrowed portion 22a is formed. Thus, ink can be prevented from stagnating in the confluence part. As a result, bubbles accumulating in the stagnant part can be effectively eliminated, and bubble discharge performance can be improved. The flow lines in this case are closer to being parallel to the axis lines (the vertical direction in the figure) of the pressure generating chambers 11 formed in the lower part the figure. Therefore, also due to this, bubbles can be favorably discharged.

FIG. 2 (b) shows a case where a reservoir 72 communicates with two ink inlets 71a and 71b at both ends thereof in the longitudinal direction, and communicates with one ink inlet 71c in the central part thereof. That is, a reservoir 72 communicates with three ink inlets 71a to 71c. In confluence areas where flows of ink introduced through the ink inlets 71a to 71c merge, narrowed portions 72a and 72b are formed. FIG. 2 (c) shows a case where a reservoir 82 is divided into three blocks, and the central parts of the blocks communicate with ink inlets 81a, 81b, and 81c. In this case, to prevent a decrease of the flow rate at the left end or the right end of the blocks at both ends of the reservoir, both ends of the reservoir 82 are narrowed and relatively small width portions 82c and 82d are formed, in addition to providing narrowed portions 82a and 82b in confluence areas where flows of ink merge. Thus, the bubble discharge function of the narrowed portions 82a and 82b and the bubble discharge function of the small width portions 82c and 82d combine, and bubbles can be favorably discharged.

FIG. 2 (d) shows a case where a reservoir 92 communicates with two ink inlets 91a and 91b at both ends thereof in the longitudinal direction. In this respect, this case is the same as the case shown in FIG. 2 (a). However, in the case shown in FIG. 2 (d), the shape of the reservoir 92 itself is formed in such a manner that the width (the size in the vertical direction in the figure) decreases gradually from the ink inlets 91a and 91b toward the confluence area along the longitudinal direction. Therefore, in this case, by the change of the width of the reservoir 92 itself, the flow of ink can be made smooth. However, the passage resistance increases, and therefore the rate of change of width needs to be adjusted with the pressure loss due to this passage resistance in mind.

In FIGS. 2 (a) to 2 (d), every one of the narrowed portion 22a and so forth has such a shape that the width gradually decreases in a predetermined confluence area from both ends toward the central part along the longitudinal direction of the reservoir 22 and so forth, and the width gradually decreases in a curve. However, the invention is not limited to this. The width of the narrowed portion 22 and so forth may gradually decrease linearly. When the width of the narrowed portion 22 and so forth gradually decreases along the flow lines of ink, ink can be made to flow the most smoothly, and the bubble discharge performance is best.

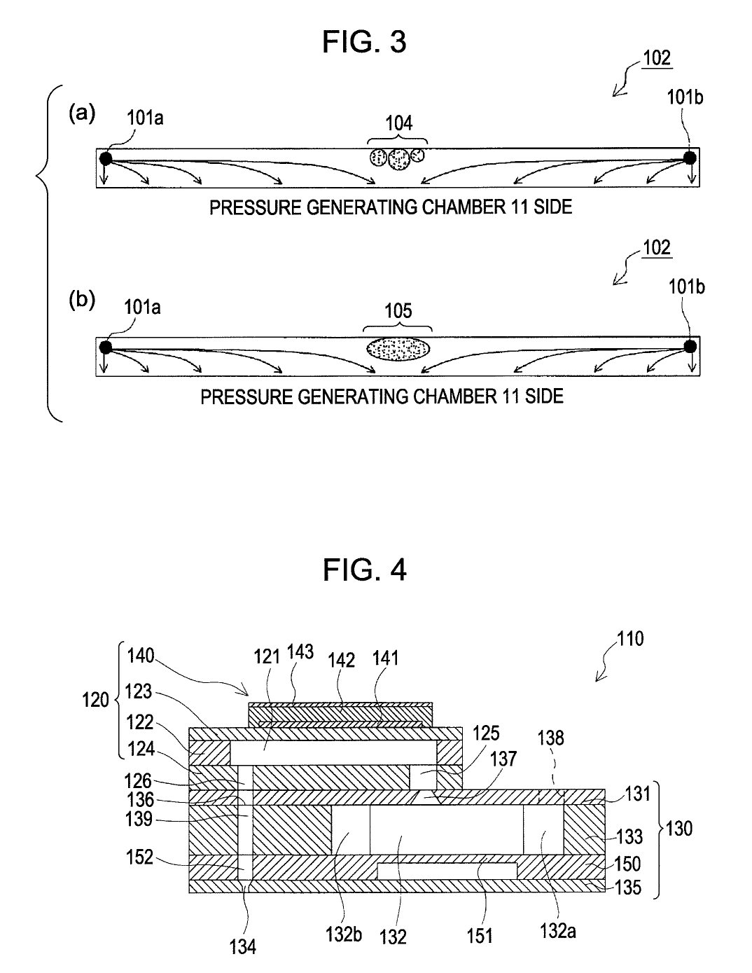

If a long-sized reservoir communicating with a plurality of ink inlets does not have any one of the narrowed portion 22a and so forth shown in FIG. 2, a problem shown in FIGS. 3 (a) and 3 (b) occurs. That is, in a reservoir 102, a stagnation area 105 such as that shown in FIG. 3 (b) is formed in a confluence area of ink supplied through ink inlets 101a and 101b. Due to this, as shown in FIG. 3 (a), bubbles 104 accumulate in the stagnation area 105 of FIG. 3 (b) and are not discharged and worsen the printing performance.

According to this embodiment described above, by varying the volumes of the pressure generating chambers 11 by the deformation of the piezoelectric elements 17 and the vibrating plate 15, ink droplets can be ejected. Specifically, after ink is supplied from an ink cartridge (not shown) through a plurality of ink inlets 21 to the reservoir 22, ink is distributed through the ink supply ports 23 to the pressure generating chambers 11. By applying a voltage to one of the piezoelectric elements 17, the piezoelectric element 17 is contracted. Thereby, the vibrating plate 15 is deformed together with the piezoelectric element 17, the volume of a corresponding one of the pressure generating chambers 11 is increased, and ink is drawn into the pressure generating chambers 11. After the inside is filled with ink to a corresponding one of the nozzle orifices 13, the voltage applied to the electrode forming materials 32 and 33 of the piezoelectric element 17 is removed according to a recording signal supplied through the wiring board. Thereby, the piezoelectric element 17 is expanded and returns to its original state, and the vibrating plate 15 is displaced and also returns to its original state. As a result, the volume of the pressure generating chamber 11 decreases, the pressure in the pressure generating chamber 11 increases, and ink is ejected from the nozzle orifice 13.

At the time of such ink ejection, ink in the reservoir 22 is guided to the narrowed portion 22a (see FIG. 2 (a)) as described above and favorably flows into the pressure generating chamber 11. As a result, ink can be prevented from stagnating in the confluence area, and favorable bubble discharge performance can be obtained.

### Second Embodiment

FIG. 4 is a sectional view of an ink jet recording head that is an example of a liquid ejection head according to a second embodiment of the invention. As shown in the figure, the ink jet recording head 110 according to this embodiment includes an actuator unit 120 and a passage unit 130 to which this actuator unit 120 is fixed.

The actuator unit 120 is an actuator unit having piezoelectric elements 140, and has a passage forming substrate 122 having pressure generating chambers 121 formed therein, a vibrating plate 123 provided on one side of the passage forming substrate 122, and a pressure generating chamber bottom plate 124 provided on the other side of the passage forming substrate 122.

The passage forming substrate 122 is formed, for example, of a plate about 150 μm thick of ceramic, such as alumina (Al2O3) or zirconia (ZrO2). In this embodiment, a plurality of pressure generating chambers 121 are provided side by side along the width direction thereof. On one side of this passage forming substrate 122, a vibrating plate 123 formed, for example, of a thin stainless-steel (SUS) plate 10 to 12 μm thick is fixed. One side of each pressure generating chamber 121 is sealed by this vibrating plate 123.

The pressure generating chamber bottom plate 124 is fixed to the other side of the passage forming substrate 122 and seals the other side of each pressure generating chamber 121. The pressure generating chamber bottom plate 124 has supply communication holes 125 and nozzle communication holes 126. Each supply communication hole 125 is provided near one end in the longitudinal direction of a corresponding one of the pressure generating chambers 121 and connects the pressure generating chamber 121 and a reservoir described below. Each nozzle communication hole 126 is provided near the other end in the longitudinal direction of a corresponding one of the pressure generating chamber 121 and communicates with a nozzle orifice 134 described below.

The piezoelectric elements 140 are provided in areas on the vibrating plate 123 facing the pressure generating chambers 121.

Each piezoelectric element 140 includes a lower electrode film 141 provided on the vibrating plate 123, a piezoelectric body layer 142 provided independently to each pressure generating chamber 11, and an upper electrode film 143 provided on each piezoelectric body layer 142. The piezoelectric body layer 142 is formed by attaching or printing a green sheet made of a piezoelectric material. The lower electrode film 141 is provided so as to cover the piezoelectric body layers 142 provided side by side, serves as a common electrode of the piezoelectric elements 140, and functions as a part of the vibrating plate. Of course, one lower electrode film 141 may be provided to each piezoelectric body layer 142.

The passage forming substrate 122, the vibrating plate 123, and the pressure generating chamber bottom plate 124 constituting layers of the actuator unit 120 are integrated without requiring adhesive by shaping a clay-like ceramic material called green sheet into a predetermined thickness, forming, for example, the pressure generating chambers 121, and thereafter laminating and firing. After that, the piezoelectric elements 140 are formed on the top of the vibrating plate 123.

On the other hand, the passage unit 130 includes a liquid supply port forming substrate 131 that is joined to the pressure generating chamber bottom plate 124 of the actuator unit 120, a reservoir forming substrate 133 in which a reservoir 132 serving as a common ink chamber of a plurality of pressure generating chambers 121 is formed, a compliance substrate 150 that is provided on the side of the reservoir forming substrate 133 opposite to the liquid supply port forming substrate 131, and a nozzle plate 135 in which nozzle orifices 134 are formed.

The liquid supply port forming substrate 131 is formed of a thin stainless steel (SUS) plate 60 μm thick and is provided with nozzle communication holes 136, ink supply ports 137, and ink inlets 138. The nozzle communication holes 136 connect the nozzle orifices 134 and the pressure generating chambers 121. The ink supply ports 137 connect the reservoir 132 and the pressure generating chambers 121 together with the supply communicating holes 125. The ink inlets 138 communicate with each reservoir 132 and supply ink from an external ink tank. The number of the ink supply ports 137 is the same as the number of the pressure generating chambers 121. The ink supply ports 137 are provided at the same pitch as that of the pressure generating chambers 121. The number of the ink inlets 138 is determined according to the size of the reservoir 132 in the longitudinal direction. Therefore, flows of ink from a plurality of places into the reservoir 132 merge in an intermediate area between adjacent ink inlets 138. That is, in the reservoir 132, a confluence area of ink is formed in an intermediate area between adjacent ink inlets 138.

The reservoir forming substrate 133 is formed of a corrosion-resistant plate material, for example, a stainless steel plate 150 μm thick, suitable to form ink passages. The reservoir forming substrate 133 has a reservoir 132 and nozzle communication holes 139. The reservoir 132 is supplied with ink from an external ink tank (not shown) and supplies ink to the pressure generating chambers 121. The nozzle communication holes 139 connect the pressure generating chambers 121 and the nozzle orifices 134.

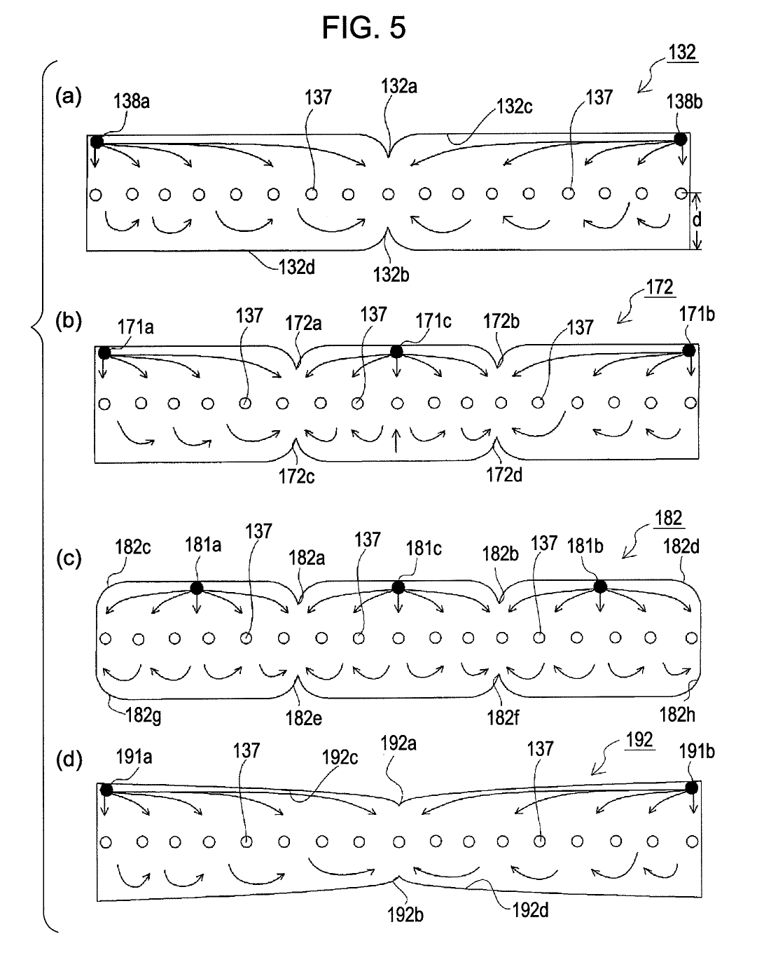

The reservoir 132 is provided so as to cover a plurality of pressure generating chambers 121, that is, in a direction in which the pressure generating chambers 121 are arranged side by side. In addition, the reservoir 132 is configured such that the width between reservoir inner walls that face each other across the ink supply ports 137 in the above-described ink confluence area is smaller than the width in the other areas. In this embodiment, narrowed portions 132a and 132b are formed in the inner walls of the reservoir 132 that face each other in the confluence area of ink, and the width of the reservoir 132 in the ink confluence area is reduced. For this point, a detailed description will be given below with reference to FIG. 5.

The compliance substrate 150 is joined to the side of the reservoir forming substrate 133 opposite to the liquid supply port forming substrate 131 and seals the bottom surface of the reservoir 132. An area of the compliance substrate 150 facing the reservoir 132 has a thickness smaller than the thickness of the other area and serves as a compliance portion 151 that is deformed by the pressure change in the reservoir 132. The compliance substrate 150 is formed, for example, of metal such as stainless steel, or ceramic. Of course, the material of the compliance substrate 150 is not limited to this. The compliance substrate 150 may be formed, for example, of an elastic film that constitutes the compliance portion 151 and a support substrate having a through hole in the thickness direction.

In addition, the compliance substrate 150 is provided with nozzle communication holes 152 that connect the nozzle orifices 134 and the nozzle communication holes 139 formed through the reservoir forming substrate 133 in the thickness direction. That is, ink from the pressure generating chambers 121 flows through the nozzle communication holes 136, 139, and 152 provided in the liquid supply port forming substrate 131, the reservoir forming substrate 133, and the compliance substrate 150, respectively, and is then ejected from the nozzle orifices 134.

The nozzle plate 135 is formed by forming nozzle orifices 134 in a thin plate formed, for example, of stainless steel, at the same arrangement pitch as the pressure generating chambers 121.

Such a passage unit 130 is formed by fixing the liquid supply port forming substrate 131, the reservoir forming substrate 133, the compliance substrate 150, and the nozzle plate 135 using adhesive or thermal welding films. Such a passage unit 130 and the actuator unit 120 are joined and fixed using adhesive or a thermal welding film.

FIG. 5 illustrates the planar shapes of various types of reservoirs according to this embodiment. The reservoir 132, in particular, the narrowed portions 132a and 132b will be described in detail with reference to the figure.

FIG. 5 (a) shows a case where a reservoir 132 communicates with two ink inlets 138a and 138b at both ends thereof in the longitudinal direction. This case corresponds to the case shown in FIG. 2 (a) in the first embodiment. In the case of the first embodiment shown in FIG. 1 and FIG. 2 (a), the reservoir 22 is configured to supply ink from a direction parallel to the surface direction of the passage forming substrate 12 through the ink supply ports 23 to the pressure generating chambers 11. Therefore, only the inner wall of the reservoir 22 facing the ink supply ports 23 is made to project to form the narrowed portion 22a.

On the other hand, in this embodiment, the ink supply ports 137 are formed between the inner walls of the reservoir 132 facing each other, and therefore providing a narrowed portion 132a to the inner wall 132c on the side of the ink inlets 138a and 138b is not enough. The reason is that ink flowing into the reservoir 132 through the ink inlets 138a and 138b stagnates in the confluence area on the side of the inner wall 132d, and bubbles caused by this stagnation grow and can flow through the ink supply ports 137 into the pressure generating chambers 121. In particular, when the distance d from the inner wall 132d to the ink supply ports 137 is larger than the size of small-diameter bubbles likely to spontaneously disappear or bubbles that one wants to discharge, grown bubbles are likely to flow through the ink supply ports 137 into the pressure generating chambers 121.

So, in this embodiment, the inner wall 132d is also provided with a narrowed portion 132b. That is, narrowed portions 132a and 132b are formed in the inner walls 132c and 132d, respectively, of the reservoir 132 facing each other in the ink confluence area so as to reduce the width of the reservoir 132 in the ink confluence area.

In FIG. 5 (a), the flow lines in this case are shown by arrows. In a confluence area where the front ends of the arrows meet, narrowed portions 132a and 132b are formed. Thus, ink can be prevented from stagnating in the confluence part. As a result, bubbles accumulating in the stagnant part can be effectively eliminated, and bubble discharge performance can be improved.

FIG. 5 (b) shows a case where a reservoir 172 communicates with two ink inlets 171a and 171b at both ends thereof in the longitudinal direction, and communicates with one ink inlet 171c in the central part thereof. This case corresponds to the case shown in FIG. 2 (b) in the first embodiment. That is, a reservoir 72 communicates with three ink inlets 171a to 171c. In confluence areas where flows of ink introduced through the ink inlets 171a to 171c merge, narrowed portions 172a and 172b are formed. In addition, narrowed portions 172c and 172d are formed across therefrom.

FIG. 5 (c) shows a case where a reservoir 182 is divided into three blocks, and the central parts of the blocks communicate with ink inlets 181a, 181b, and 181c. This corresponds to the case shown in FIG. 2 (c) in the first embodiment. In this case, to prevent a decrease of the flow rate at the left end or the right end of the blocks at both ends of the reservoir, both ends of the reservoir 182 are narrowed and relatively small width portions 182c and 182d are formed, in addition to providing narrowed portions 182a and 182b in confluence areas where flows of ink merge. In addition, narrowed portions 182e and 182f are provided across from the narrowed portions 182a and 182b, respectively, and small width portions 182g and 182h are provided across from the small width portions 182c and 182d, respectively.

Thus, the bubble discharge function of the narrowed portions 182a, 182b, 182e, and 182f and the bubble discharge function of the small width portions 182c, 182d, 182g, and 182h combine, and bubbles can be favorably discharged.

FIG. 5 (d) shows a case where a reservoir 192 communicates with two ink inlets 191a and 191b at both ends thereof in the longitudinal direction. In this respect, this case is the same as the case shown in FIG. 5 (a). However, in the case shown in FIG. 5 (d), the shape of the reservoir 192 itself is different. The inner wall 192c is formed in such a manner that the width (the size in the vertical direction in the figure) decreases gradually from the ink inlets 191a and 191b toward the confluence area along the longitudinal direction. In addition, the inner wall 192d across therefrom is formed in a shape symmetrical thereto. Thus, narrowed portions 192a and 192b are formed in the ink confluence area.

Therefore, in this case, by the change of the width of the reservoir 192 itself, the flow of ink can be made smooth. However, the passage resistance increases, and therefore the rate of change of width needs to be adjusted with the pressure loss due to this passage resistance in mind.

In FIGS. 5 (a) to 5 (d), every one of the narrowed portion 132a and so forth has such a shape that the width gradually decreases in a predetermined confluence area from both ends toward the central part along the longitudinal direction of the reservoir 132 and so forth, and the width gradually decreases in a curve. However, the invention is not limited to this. The width of the narrowed portion 132a and so forth may gradually decrease linearly. When the width of the narrowed portion 132a gradually decreases along the flow lines of ink, ink can be made to flow the most smoothly, and the bubble discharge performance is best.

According to this embodiment described above, ink is taken into the reservoir 132 from an ink cartridge (storage means) through a plurality of ink inlets 138, and the insides of the ink passages from the reservoir 132 to the nozzle orifices 134 are filled with ink. Thereafter, according to a recording signal from a driving circuit (not shown), a voltage is applied to each piezoelectric element 140 corresponding to each pressure generating chamber 121, and the vibrating plate 123 is bent together with the piezoelectric elements 140. Thereby, the pressure in each pressure generating chamber 121 increases, and an ink droplet is ejected from each nozzle orifice 134.

At the time of such ink ejection, ink in the reservoir 132 is guided to the narrowed portions 132a and 132b in the confluence area as described above, and favorably flows into the pressure generating chambers 121. As a result, ink can be prevented from stagnating in the confluence part, and favorable bubble discharge performance can be obtained.

### Other Embodiments

In the above embodiments, a description is given of an ink jet recording head having longitudinal vibration type piezoelectric elements in which piezoelectric material and electrode forming material are alternately laminated and that expand and contract in the axial direction. However, the type of ink jet recording head is not limited as long as the ink jet recording head has a reservoir. For example, an ink jet recording head having thick-film type piezoelectric elements; an ink jet recording head having thin-film type piezoelectric elements having piezoelectric material formed by, for example, a sol-gel method, a MOD method, or a sputtering method; an ink jet recording head having so-called static actuators in which a vibrating plate and an electrode are arranged with a predetermined gap therebetween and the vibration of the vibrating plate is controlled by electrostatic force; and an ink jet recording head in which a heater element is disposed in each pressure generating chamber and a bubble generated by the heat of the heater element ejects a liquid droplet from a nozzle orifice, can achieve the same effect.

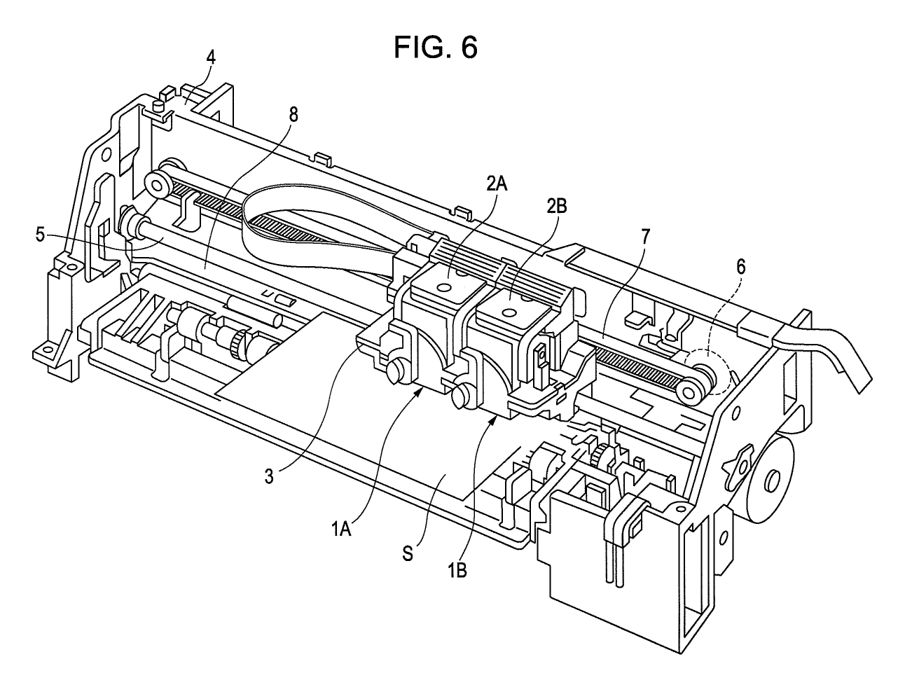

The ink jet recording head according to any one of the above embodiments constitutes a part of a recording head unit having ink inlets communicating, for example, with an ink cartridge, and is mounted in an ink jet recording apparatus. FIG. 6 is a schematic diagram showing an example of the ink jet recording apparatus. As shown in the figure, cartridges 2A and 2B constituting ink supply means are detachably provided to recording head units 1A and 1B, respectively, each having an ink jet recording head, and a carriage 3 on which the recording head units 1A and 1B are mounted is provided to a carriage shaft 5 attached to the apparatus main body 4, movably in the axial direction. These recording head units 1A and 1B eject, for example, black ink composition and color ink composition, respectively.

The driving force of a driving motor 6 is transmitted via a plurality of gears (not shown) and a timing belt 7 to the carriage 3. Thereby, the carriage 3 on which the recording head units 1A and 1B are mounted is moved along the carriage shaft 5. On the other hand, an apparatus main body 4 is provided with a platen 8 along the carriage shaft 5, and a recording sheet S that is a recording medium, such as paper, fed by a paper feed roller (not shown) or the like is transported on the platen 8.

In the above-described embodiments, a description is given of an ink jet recording head as an example of a liquid ejection head. However, the present invention can be applied to any liquid ejection head and, of course, can also be applied to a method for inspecting a liquid ejection head that ejects liquid other than ink. Other examples of a liquid ejection head include various recording heads used in an image recording apparatus such as a printer, a color material ejection head used for manufacturing color filters for a liquid crystal display or the like, an electrode material ejection head used for forming electrodes of an organic EL display, FED (field emission display), or the like, and a bioorganic substance ejection head used for manufacturing biochips.

What is claimed is:

1. A liquid ejection head comprising:
pressure generating chambers that marshal in a first substrate so as to be made to eject liquid through nozzle orifices by pressure variation; and
a reservoir that is provided in a second substrate so as to supply the liquid to the pressure generating chambers and to constitute a common liquid chamber provided in the direction in which the pressure generating chambers marshal;
the reservoir being supplied with the liquid through a plurality of liquid inlets, and
the reservoir's cross-sectional area, in a confluence area of the liquid supplied through the liquid inlets, being smaller than the reservoir's cross-sectional area in a predetermined area other than the confluence area.

2. The liquid ejection head according to claim 1, the reservoir supplying the liquid to the pressure generating chambers through liquid supply ports in the direction along the surface of the second substrate, and an inner wall of the reservoir that faces the liquid supply ports in the confluence area projects toward the liquid supply ports.

3. The liquid ejection head according to claim 1, the reservoir supplies the liquid to the pressure generating chambers through liquid supply ports in the direction of the thickness of the second substrate, and inner walls of the reservoir that extend with the liquid supply ports therebetween in the direction in which the pressure generating chambers are provided side by side, project toward each other in the confluence area.

4. The liquid ejection head according to claim 3, both of the reservoir's inner walls, that extend with the liquid supply ports therebetween in the direction in which the pressure generating chambers marshal, are distant from the liquid supply ports by a distance larger than the maximum diameter of bubbles that can spontaneously disappear in the predetermined area.

5. The liquid ejection head according to claim 1, at least one narrowed portion being formed in the confluence area.

6. The liquid ejection head according to claim 5, the at least one narrowed portion having such a shape that the width gradually decreases in the direction in which the pressure generating chambers are provided side by side, from the sides of the liquid inlets toward the intermediate part between adjacent liquid inlets.

7. The liquid ejection head according to claim 5, the width of the at least one narrowed portion gradually decreasing along the flow line of the liquid.

8. The liquid ejection head according to claim 5, the at least one narrowed portion including a plurality of narrowed portions provided in the reservoir.

9. A liquid ejection apparatus having the liquid ejection head according to claim 1.
